(19) United States
(12) Patent Application Publication
(10) Pub. No.: US 2019/0214823 A1
(43) Pub. Date: Jul. 11, 2019

(54) ENERGY MANAGEMENT SYSTEM, GUIDE SERVER AND ENERGY MANAGEMENT METHOD

(71) Applicants: NEC Corporation, Tokyo (JP); NEC Platforms, Ltd., Kanagawa (JP)

(72) Inventors: Alexander VIEHWEIDER, Tokyo (JP); Nao TSUMAGARI, Tokyo (JP); Kuniya SHOJI, Kanagawa (JP); Toshihiro KAMIMAKI, Tokyo (JP); Naomichi TAKAHASHI, Tokyo (JP); Shantanu CHAKRABORTY, Tokyo (JP); Ryota MICHINO, Tokyo (JP)

(73) Assignees: NEC Corporation, Tokyo (JP); NEC Platforms, Ltd., Kanagawa (JP)

(21) Appl. No.: 16/307,722

(22) PCT Filed: Jun. 7, 2016
(86) PCT No.: PCT/JP2016/002729

§ 371 Date: Dec. 6, 2018

(51) Int. Cl. H02J 3/32; H02J 3/38

(52) U.S. Cl. CPC H02J 3/32; H02J 2003/003; H02J 3/38

(57) ABSTRACT

An energy management system includes energy storage, a load, a guide server and a local controller. The energy storage is configured to be charged and discharged, and connected to a grid line, the grid line being supplied with power from an outside power generator. The load is configured to operate with consuming power supplied via the grid line. The guide server is configured to predict conditions of the energy storage, the load and the grid line and to generate a directive corresponding to the prediction, and outputs the generated directive. The local controller is configured to control charging and discharging of the energy storage based on or guided by the directive generated in the guide server.

### TECHNICAL FIELD

The present invention relates to an energy management system, a guide server and an energy management method.

### BACKGROUND ART

Recently, an energy management system (EMS) such as a home energy management system (HEMS) has been developed for controlling and saving power consumption.

As a system similar to the EMS, a social infrastructure control system is disclosed (Patent Literature 1). The social infrastructure control system includes a control apparatus and a server. The control apparatus includes a collection unit, a transmission unit, a reception unit and a control unit. The collection unit collects sensing data concerning control targets in the social infrastructure. The transmission unit transmits the collected sensing data to the server via the communication network. The reception unit receives, from the server, a control instruction to control the control targets. The control unit controls the control targets based on the received control instruction. The server includes an acquisition unit, a database, a generation unit and an instruction unit. The acquisition unit acquires the sensing data from the control apparatus via the communication network and stores the acquired sensing data in the database. The generation unit generates the control instruction by processing the sensing data stored in the database. The instruction unit transmits the generated control instruction to the control apparatus. And the control unit executes control of control targets based on the control instruction at a timing based on a priority defined for each control target.

Further, as another example, an automated demand response energy management system is disclosed (Patent Literature 2). In this system, the power flexibility of energy loads is maximized using a value function for each load and outputting optimal control parameters. Loads are aggregated into a virtual load by maximizing a global value function. The solution yields a dispatch function providing: a percentage of energy for each individual load, a time-varying power level for each load, and control parameters and values. An economic term represents the value of the power flexibility to different players. A user interface includes for each time interval upper and lower bounds representing respectively the maximum power that may be reduced to the virtual load and the maximum power that may be consumed. A trader modifies an energy level in a time interval relative to the reference curve for the virtual load. Automatically, energy compensation for other intervals and recalculation of upper and lower boundaries occurs. The energy schedule for the virtual load is distributed to the actual loads.

### CITATION LIST

### Patent Literature

PTL 1: International Patent Publication No. WO2013/172088

PTL 2: Published Japanese Translation of PCT International Publication for Patent Application, No. 2015-506031

### SUMMARY OF INVENTION

### Technical Problem

In the EMS, it is necessary to predict future conditions of the system including devices such as an energy storage (e.g. a battery) and a load (lighting equipment, an air conditioner, etc.), and provide the devices with directives to appropriately control the devices in order to adapt temporal changing of the conditions due to variations of power supply, power consumption and a time uncertain phenomenon (e.g., a blackout etc.).

The present invention has been made in view of the above-mentioned problem, and an object of the present invention is to make an energy management system possible to control devices by predicting a change of condition (or a set of probable conditions) in advance.

### Solution to Problem

An aspect of the present invention is an energy management system including: an energy storage configured to be charged and discharged, and connected to a grid line, the grid line being supplied with power from at least one outside power generator or from the energy storage itself; a load configured to operate with consuming power supplied via the grid line; a guide server configured to predict conditions of the energy storage, the load and the grid line and to generate a directive corresponding to the prediction, and outputs the generated directive; and a local controller configured to control charging and discharging of the energy storage based on the directive generated in the guide server.

An aspect of the present invention is a guide sever for predicting conditions of an energy storage, a load and a grid line and generating a directive corresponding to a prediction, and outputting the generated directive, the energy storage being configured to be charged and discharged, and connected to a grid line, the grid line being supplied with power from at least one outside power generator or from the energy storage itself, the load being configured to operate with consuming power supplied via the grid line, charging and discharging of the energy storage is controlled by a local controller based on the directive, the guide server including: a generation prediction unit configured to predict power generation of the outside power generator; a load prediction unit configured to predict power consumption of the load; the time uncertain phenomena prediction unit being configured to predict probable occurrences of time uncertain phenomena; a generation prediction buffer configured to store a prediction generated by the generation prediction unit; a load prediction buffer configured to store a prediction generated by the load prediction unit; and a time uncertain phenomena prediction buffer configured to store a prediction generated by the time uncertain phenomena prediction unit. When the controller determines to generate the directive, the generation prediction unit, the load prediction unit and the time uncertain phenomena prediction unit generates predictions and outputs the generated predictions. the load prediction buffer and the time uncertain phenomena prediction buffer, respectively, and the optimizer reads in the predictions from the generation prediction buffer, the load prediction buffer and the time uncertain phenomena prediction buffer to generate the directive.

An aspect of the present invention is an energy management method including: predicting conditions of an energy storage, a load and a grid line, the energy storage being configured to be charged and discharged, and connected to the grid line, the grid line being supplied with power from at least one outside power generator or from the energy storage itself, the load being configured to operate with consuming power supplied via the grid line; generating a directive corresponding to the prediction; outputting the generated directive; and controlling the charging and discharging of the energy storage based on the generated directive.

### Advantageous Effects of Invention

According to the present invention, it is possible to make an energy management system possible to control devices by predicting a change of situation in advance and/or possible resulting situations or situational changes in advance and providing advantageous directive-based control commands for energy saving and/or other purposes.

### BRIEF DESCRIPTION OF DRAWINGS

FIG. 1 is a block diagram schematically illustrating a configuration of an energy management system according to a first embodiment.

FIG. 2 is a block diagram schematically illustrating a configuration of a guide server according to the first embodiment.

FIG. 3 is a block diagram schematically illustrating an exemplary configuration of a load prediction unit.

FIG. 4 is a block diagram schematically illustrating an exemplary configuration of a time uncertain phenomena prediction unit.

FIG. 5 is a block diagram schematically illustrating an exemplary configuration of each of a generation prediction buffer, a load prediction buffer, and a time uncertain phenomena prediction buffer.

FIG. 6 is a block diagram schematically illustrating an exemplary configuration of an optimizer.

FIG. 7 is a diagram schematically illustrating an outline of a specific example of a directive.

FIG. 8 is a diagram illustrating a charging operation of an energy storage in different control conditions.

FIG. 9 is a diagram schematically illustrating overlaps of the directives.

FIG. 10 is a diagram schematically illustrating charging and discharging operation according to a third embodiment.

FIG. 11 is a diagram schematically illustrating an exemplary configuration of the guide server.

### DESCRIPTION OF EMBODIMENTS

Exemplary embodiments of the present invention will be described below with reference to the drawings. In the drawings, the same elements are denoted by the same reference numerals, and thus a repeated description is omitted as needed.

### First Embodiment

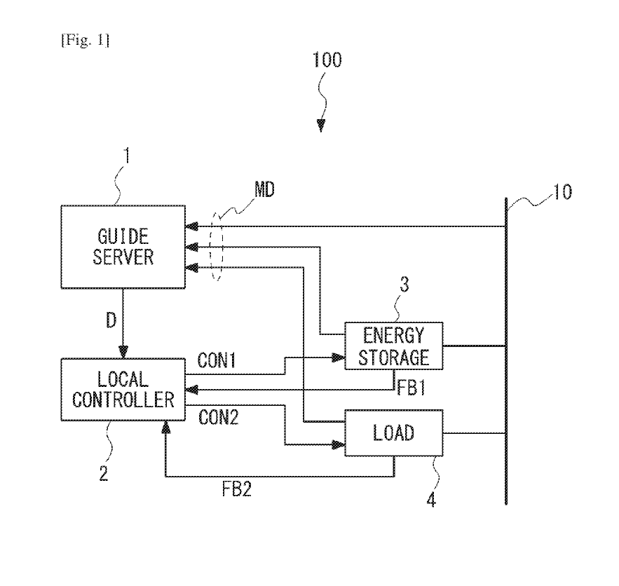

An energy management system according to a first embodiment will be described. FIG. 1 is a block diagram schematically illustrating a configuration of an energy management system 100 according to the first embodiment. The energy management system 100 includes a guide server 1, a local controller 2, an energy storage 3 such as a battery, and a load 4.

The guide server 1 sends a directive to the local controller. The energy storage 3 and the load 4 are connected to a grid line 10 which is supplied power from a trunk line or a core system. For example, the energy storage 3 and the load 4 are provided as devices disposed in a house (a household device) or a building. The energy storage 3 can be appropriately charged and discharged according to conditions of the grid line 10 and the load 4. Further, the guide server 1 can receive information indicating the conditions of the energy storage 3 and the load 4, and thereby send the directive based on the information from the energy storage 3 and the load 4 to perform feed-back controls of the energy storage 3.

The local controller 2 controls a charge operation and a discharge operation of the energy storage 3, for example, by outputting a control signal CON1. The local controller 2 also may control an operation of the load 4, for example, by outputting a control signal CON2. Note that the local controller 2 may receive information FB1, FB2 indicating the conditions of the energy storage 3 and the load 4, and send the received information to the guide sever 1.

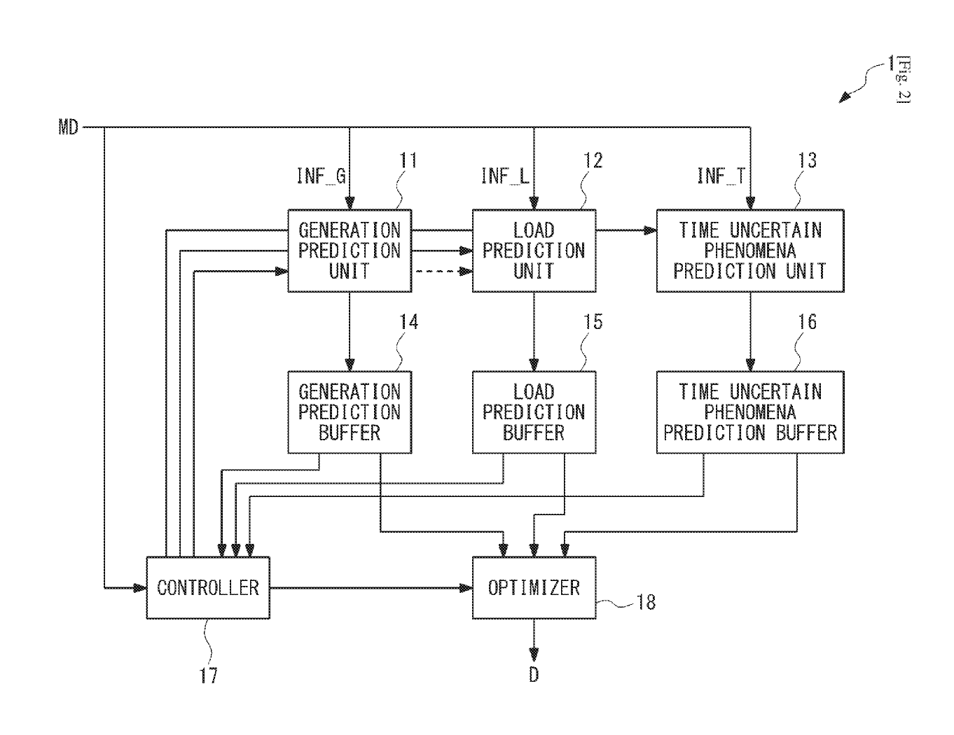

The guide server 1 will be described in detail. FIG. 2 is a block diagram schematically illustrating a configuration of the guide server 1 according to the first embodiment. The guide server 1 includes a generation prediction unit 11, a load prediction unit 12, a time uncertain phenomena prediction unit 13, a generation prediction buffer 14, a load prediction buffer 15, a time uncertain phenomena prediction buffer 16, a controller 17, and an optimizer 18.

Generation information INF_{—G} included in measurement data, which indicates power supplied to the energy storage 3 and the load 4 via the grid 10, is input to the generation prediction unit 11 from an outside power generator (e.g. a photovoltaic cell, etc.) generating the power. Load information INF_{—L} included in the measurement data, which indicates a load value of the load 4, is input to the load prediction unit 12. Time uncertain phenomena information INF_{—T} included in the measurement data, which indicates time uncertain phenomena, is input to the time uncertain phenomena prediction unit 13. Further, information of power prediction (PV power, wind power or others) prediction indicated by dashed arrow from the generation prediction unit 11 to the load prediction unit 12 may be supplied to the load prediction unit 12 since the PV generation prediction (which is typically based on irradiation prediction) could be used for A/C operation prediction and the wind prediction could be used for building cooling power prediction (since these properties indirectly influence the respective operations), etc.

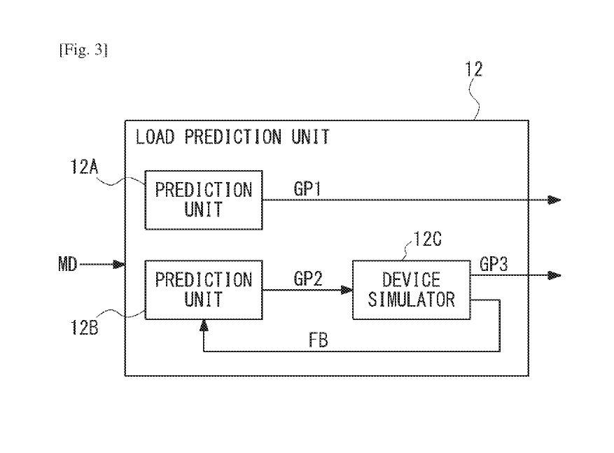

FIG. 3 is a block diagram schematically illustrating an exemplary configuration of the load prediction unit 12. The load prediction unit 12 includes a prediction unit 12A, 12B and a device simulator 12C. The prediction unit 12A is configured to predict non-feedback-type phenomena affecting the state of the load 4 and outputs a resulting prediction GP1. The prediction unit 12B is configured to predict an internal state of the load 4 and outputs a resulting prediction GP2 by performing a feed-back operation using the measurement data MD and information from the device simulator 12C. The device simulator 12C processes the predictions GP2 received from the prediction unit 12B, and outputs a resulting prediction GP3. Further, the device simulator 12C also feeds back information FB based on the generated prediction GP3 to the prediction unit 12B, and the prediction unit 12B can perform the feedback operation on the prediction generated therein.

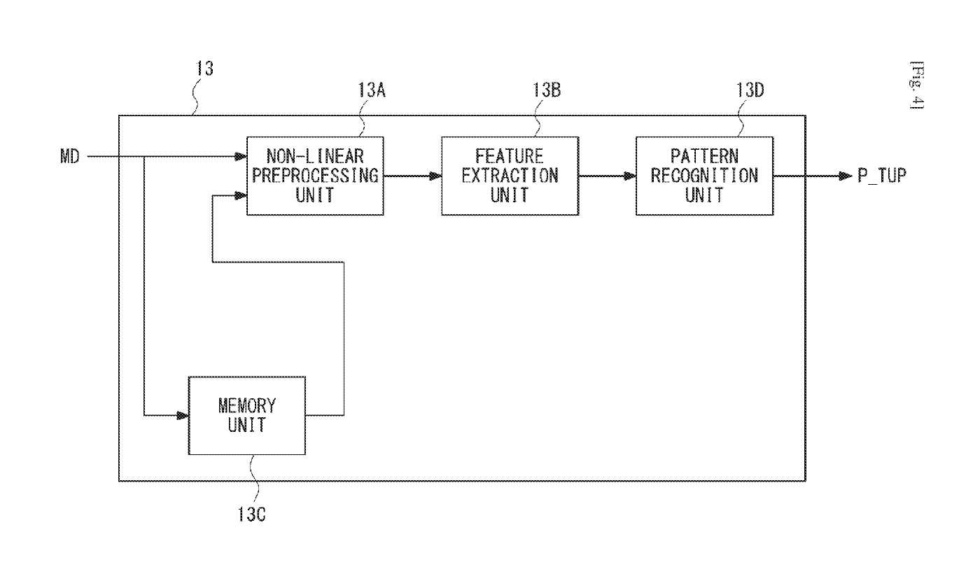

FIG. 4 is a block diagram schematically illustrating an exemplary configuration of the time uncertain phenomena prediction unit 13. The time uncertain phenomena prediction unit 13 includes a nonlinear pre-processing unit 13A, a feature extraction unit 13B, a memory unit 13C, and a pattern recognition unit 13D. Here, the time uncertain phenomena mean timely sporadic operations of devices such as on/off of the devices (e.g. house hold devices or machines in a factory). The nonlinear pre-processing unit 13A receives the latest measurement data MD from the outside and the internal data including past measurement data from the memory unit 13C, and outputs the processed data to the feature extraction unit 13B. The feature extraction unit 13B extracts a feature from the input data and outputs the extracted feature to the pattern recognition unit 13D. The pattern recognition unit 13D determines to which the region of the feature space the extracted feature belongs (P_{—TUP} in FIG. 4). This region is associated with particularly concrete duration. The memory unit 13C stores the particularly past parameters such as the last duration of the time uncertain phenomenon. When the pattern recognition unit 13D determines that the input thereof simultaneously belongs to the different regions, probabilities (or a probability function) of the duration of the time uncertain phenomena are inferred from the degree of belonging to each region (e.g. the degree is determined by a distance from a region center.).

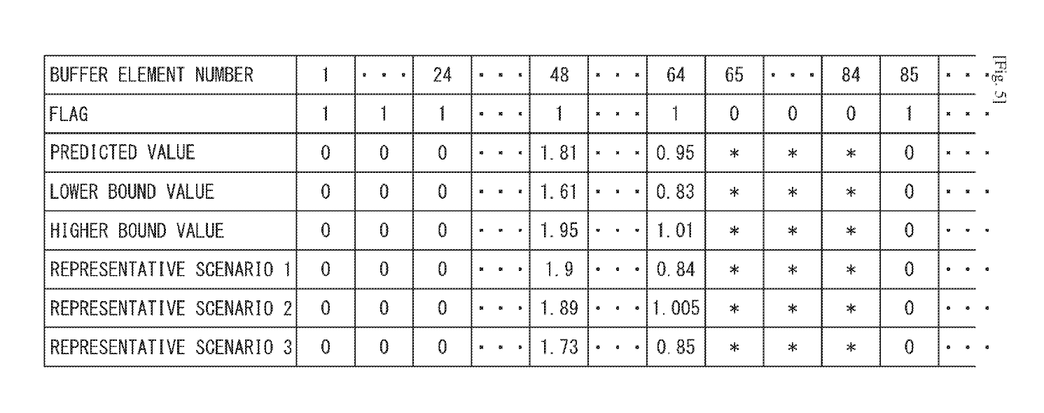

The generation prediction buffer 14, the load prediction buffer 15, and the time uncertain phenomena prediction buffer 16 can store the predictions for predefined interval (e.g. for one day). FIG. 5 is a block diagram schematically illustrating an exemplary configuration of each of the generation prediction buffer 14, the load prediction buffer 15, and the time uncertain phenomena prediction buffer 16. Each buffer includes a plurality of slots corresponding to the temporal resolution. For example, when the temporal resolution is five minutes, 288 slots are provided for one day. Each slot contains the predicted values from each of the generation prediction unit 11, the load prediction unit 12 and the time uncertain phenomena prediction unit 13, a flag for each predicted value, upper bound value for each predicted value, and a lower bound value for each predicted value. Each flag is set according to the corresponding predicted value. For example, each flag is set to “0” when the corresponding predicted value is not valid, “1” when the corresponding predicted value is valid, “2” when the corresponding predicted value is unreliable, and “3” when the corresponding predicted value is assumed. The upper bound value and lower bound value represent a range of uncertainty of the prediction so that the optimizer can exploit this additional information for optimal robust directive calculation. Instead of upper bound and lower bound description type of the uncertainty, representative scenarios—if available—can be used for optimal robust directive calculation.

The controller 17 can trigger operations of the generation prediction unit 11, the load prediction unit 12, the time uncertain phenomena prediction unit 13, and the optimizer 18. The controller 17 causes the generation prediction unit 11, the load prediction unit 12, and the time uncertain phenomena prediction unit 13 to start predicting. In other words, the controller 17 reinitiates the predictions. Further, the controller 17 causes the optimizer 18 to generate the directive based in the reinitiated predictions. The triggering is performed as described below, for example.

### Case A: Prediction Deviation Check

The controller 17 performs the triggering, when the latest predicted values read out from the generation prediction buffer 14, the load prediction buffer 15, and the time uncertain phenomena prediction buffer 16 are not compatible with the measurement data MD or the deviation between the measurement data MD and the latest predicted value is larger than a predetermined value.

### Case B: Time Uncertain Phenomenon Trigger

When the time uncertain phenomenon occurs, the controller 17 performs the triggering after a predefined time from the occurrence of the time uncertain phenomenon.

### Case C: Prediction Validity Check

The controller 17 periodically performs the triggering in order to perform a periodic update of the predictions and directives. In this case, an interval value between the periodic updates can be stored in an internal memory provided in the controller 17.

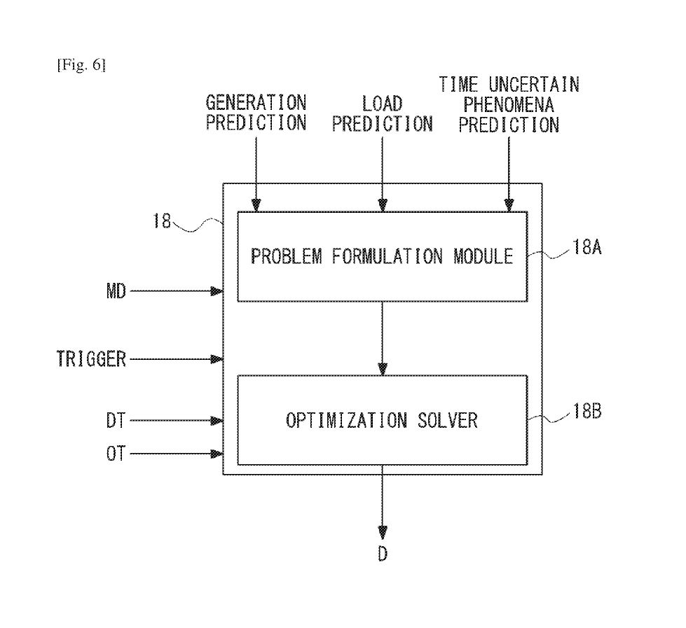

FIG. 6 is a block diagram schematically illustrating an exemplary configuration of the optimizer 18. The optimizer 18 includes a problem formulation module 18A and an optimal solver 18B. The problem formulation module 18A reads the prediction buffers. Specifically, the problem formulation module 18A reads out the generation type of the outside power generator (e.g. a photovoltaic cell) from the power generation prediction buffer 14, and/or reads out the demand type of the load 4 (e.g. a type of house hold device such as an air conditioner, an induction heating cooking heater) from the load prediction buffer 15, and/or time uncertain phenomenon from the time uncertain phenomena prediction buffer 16. The problem formulation module 18A further reads out the local EMS (energy management system) model, desired directive type, an user objective, for example from an internal memory provided in the optimizer 18. The local EMS model is typically configured by differential algebraic equations or hybrid models, and associated constraints-inequalities in automatic readable form. The desired directive type is also expressed in automatic readable and processable form. The user objective is defined to each site. Then, the problem formulation module 18A calculates necessary parameters for an optimal solver 18B using the read information. Here, various types of classical optimization solvers (e.g. a LP(Linear Programming)-solver, a MILP(Mixed Integer Linear Programming)-solver, and a QLP(Quadratic Linear Programming)-solver) can be used as the optimal solver 18B. The optimization solver 18B with some postprocessing outputs the calculated parameters as the m-tuple of the optimal directive to the local controller 2. Additionally, directive properties or type describing information DT and optimization goal type describing information OT are supplied to the optimizer 18. The directive properties or type describing information DT includes properties of the directive properties or type describing information DT, i.e. the concrete structure of the j-tuple and how the tuple has to be interpreted, in machine-readable format. The j-tuple describes the parameter of the local control policy to use the expression local control policy. For optimization purposes, the local control policy itself must be described in machine-readable format. The optimization goal type describing information OT includes preferences for optimization. That is, the optimization goal type describing information OT includes some cost associated with the start and stop of an additional power generator, or how energy storage deterioration is mapped to operation costs, etc.

Next, a specific example of the directive for controlling charging and discharging of the energy storage 3 is controlled will be described in detail. Here, the directive D is defined by a plurality of parameters as shown in a following expression, where Ts is the start time of a control based on the directive D, Te is the end time of the control based on the directive D, and P is a j-tuple for controlling the charge and discharge of the energy storage 3 which is configured as a matrix.

D=[Ts,Te,P] (1)

In the present embodiment, an example where the j-tuple

### P(j=3)

includes three vectors
Pₘᵢₙ, Pₘᵢₙ, s
will be described.

### Pₘᵢₙ

is a vector configured by a sequence of energy storage charging lower bounds of the energy storage 3 p_{min,1} to p_{min,n}, where n is an integer equal to or more than one.

$${p}_{m i n} = ( \begin{matrix}{p}_{m i n , 1} \\ M \\ {p}_{m i n , n}\end{matrix} ) \qquad ( 2 )$$

### Pₘᵢₙ

is a vector configured by a sequence of energy storage charging higher charging bounds p_{max,1} l to p_{max,m}, where m is an integer equal to or more than one.

$${p}_{m ax} = ( \begin{matrix}{p}_{m ax , 1} \\ M \\ {p}_{m ax , m}\end{matrix} ) \qquad ( 3 )$$

s
is a vector configured by a sequence of energy storage charging power s_{min,1}to s_{min,k}, where k is an integer equal to or more one.

$${s}_{m ax} = ( \begin{matrix}{s}_{1} \\ M \\ {s}_{k}\end{matrix} ) \qquad ( 4 )$$

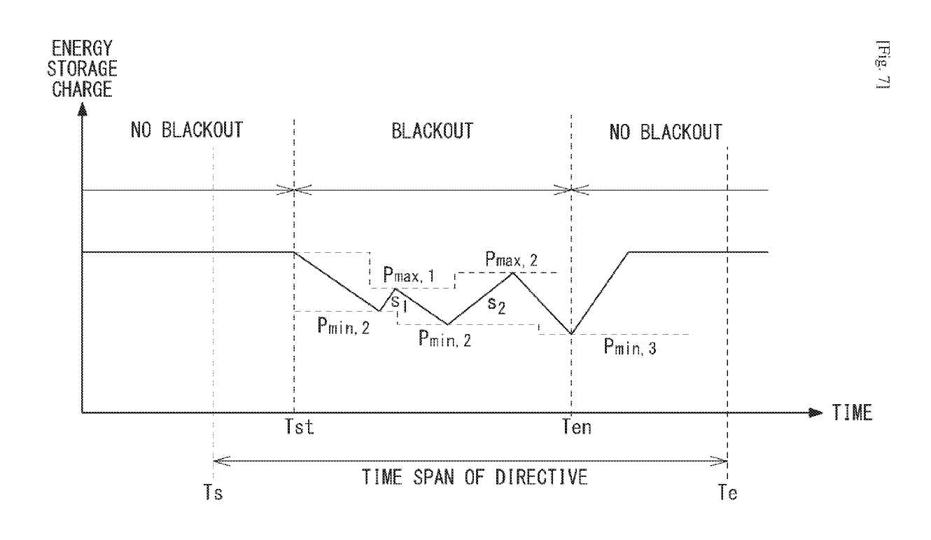

FIG. 7 is a diagram schematically illustrating an outline of the specific example of the directive. The power line supplies enough power via the grid 10 before the start time Tst, the energy storage 3 is not required to supply the power. Thus, the energy storage 3 is fully charged before the start time Tst.

However, the power supply from the trunk line may be stopped and a blackout may occur due to some needed planned or unplanned maintenance action in the electric generation plant or some accidents such as a fire in the electric generation plant. In this case, the energy storage 3 has to start to supply the power in order to maintain the operation of the load 4. The energy storage starts to supply the power at the start time Tₛₜ. As described above, the guide server 1 constantly monitors the state of the system including the power supply from the electric generation plant. For example, the guide server 1 can provide the local controller 2 with the directive generated from the prediction in which the occurrence of blackout, which can be predictable like planned blackout, is reflected as the time uncertain phenomenon, so that the start time Tₛₜ in advance of the occurrence of blackout can be defined beforehand by the directive and/or this knowledge be used even to determine the optimal directive itself.

The first discharge starts at the start time Tₛₜ. After that, when the charge of the energy storage 3 decreases to the P_{min,1}, the charging of the energy storage 3 starts. Then, when the charge of the energy storage 3 increases to p_{max,l}, the discharging of the energy storage 3 starts. In this way, a i-th (i is an integer from 1 to n,m) cycle of charging and discharging of the energy storage 3 is configured. As illustrated in FIG. 7, the cycles are repeated in a time span between the start time Tₛₜ and the end time Tₑₙ within the range defined by the energy storage charging lower bounds pₘᵢₙ and the energy storage charging higher bounds p_{max.}

Then, the energy storage stops supplying the power at the end time Tₑₙ. As the start time Tₛₜ, the guide server 1 can provide the local controller 2 with the directive generated from the prediction in which the restart of the power supply from the electric power plant is reflected, so that the end time Tₑₙ in advance of the restart of the power supply can be defined beforehand by the directive or a set of probable end-times indicated by the directive.

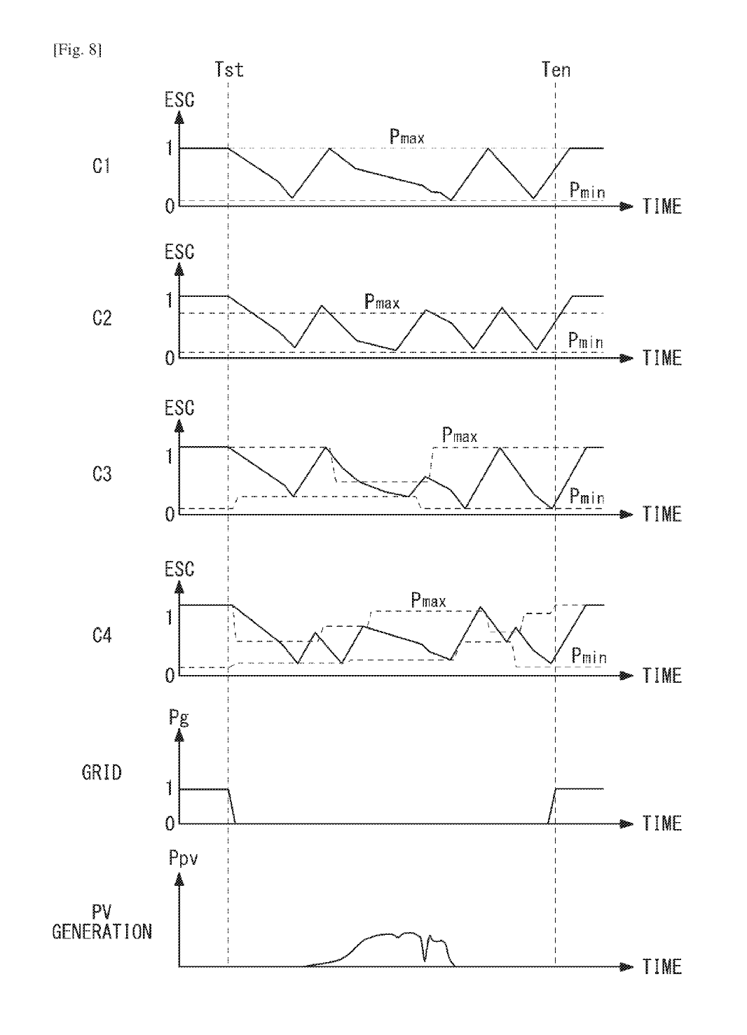

Subsequently, the charging operation of the energy storage 3 is further described in different control conditions. FIG. 8 is a diagram illustrating the charging operation of the energy storage 3 in the different control conditions. In FIG. 8, “energy storage charge” is abbreviated as “ESC”. In FIG. 8, different conditions C1 to C4 are illustrated. The control conditions C1 to C2 are the comparative examples and the control condition corresponds to the present embodiment.

In control condition C1, the energy storage 3 is discharged to the lowest charge level (0) and charged to the highest level (1) in a blackout span. In control condition C2, the energy storage 3 is discharged to the lowest charge level (0) and charged to a fixed higher bound in a blackout span.

In control condition C3, the energy storage 3 is discharged and charged in the control manner according to the present embodiment in a blackout span. In this condition, the charging of the energy storage 3 is limitedly changed within the range defined by the energy storage charging lower bounds

### Pₘᵢₙ

and the energy storage charging higher bounds

### Pₘₐₓ.

When the generation power level of the auxiliary generation system such as the photovoltaic cell (PV) is high, the main discharge of the energy storage 3 is carried out. Then, when the generation power level of the auxiliary generation system is low, main charge of the energy storage 3 is carried out. Therefore, the charging and discharging operation can be changed according to the variation of the generation power level of the auxiliary generation system. Further, the wide range charging and discharging can be minimized, so that the lifetime of the energy storage 3 can be extend more than the comparative control conditions C1 to C2.

Also in control condition C4, the energy storage 3 is discharged and charged in the control manner according to the present embodiment in a blackout span. In this condition, the charging of the energy storage 3 is limitedly changed within the range defined by the energy storage charging lower bounds

### Pₘᵢₙ

and the energy storage charging higher bounds

### Pₘₐₓ.

The difference to control condition C3 is that the starting of the electric power generator during the blackout span is integrated in the optimization criteria (FIG. 6, OT) with lower starting cost assumption.

Therefore, the parameters of the directive are different and lead to a charge/discharge pattern described by

### Pₘᵢₙ

and

### Pₘₐₓ

which differs significantly from condition 3. (ex. the number of electric power generator starts is reduced).

As described above, according to the present invention, it is possible to make an energy management system possible to control devices by predicting a change of situation in advance and/or possible resulting (probable) situations or situational changes in advance and providing advantageous directive-based control commands for energy saving and/or other purposes.

### Second Embodiment

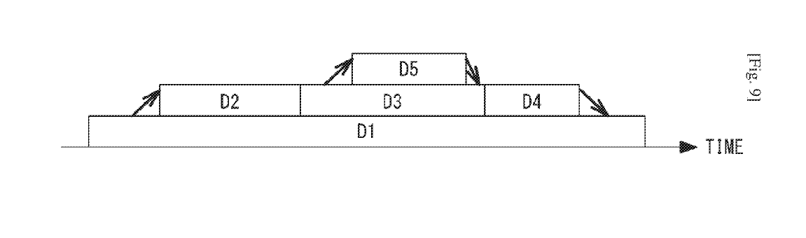

In a second embodiment, an overlap of the directives will be described. In the energy management system, a plurality of the directives to the particular energy storage (the energy storage 3) can be overlapped and times spans indicated by these directives can be different from each other. FIG. 9 is a diagram schematically illustrating the overlap of the directives. In this case, the local controller 2 holds a plurality of the directives and determines which directive has a priority to be executed. In FIG. 9, a directive D1 whose time span is the longest is overlapped with directives D2 to D4. Further, the directive D3 is overlapped with a directive D5 whose time span is shorter than that of the directive D3. In this embodiment, when a plurality of the directives are overlapped, the single directive whose time span is the shortest has the top priority.

In this case, the directive D1 is valid at an initial situation. Then, the directive D2 is valid and the directive D1 is invalid, because a time span of the directive D2 is shorter than that of the directive D1. After the time span of the directive D2, the directive D3 is valid, and then the directive D5 is valid and the directive D3 is invalid because the time span of the directive D5 is shorter than that of the directive D3. After the time span of the directive D5, the directive D3 is valid again. Further, after the time span of the directive D3, the directive D4 is then valid. After the time span of the directive D4, the directive D1 is valid again.

As described above, according to the present embodiment, the directive whose time span is the shortest is preferentially valid so that it is possible to perform a precise control for the energy storage 3 according to temporary variation of the power supply and the load value of the load 4.

### Third Embodiment

In a third embodiment, another example of the directive will be described. In the present embodiment, an example where the j-tuple

### P(j=2)

includes number of full charging and discharging cycles N and a higher limit bound HLB. N is an integer equal to or more than one and HLB is a value from 0 to 1.

P={N,HLB} (5)

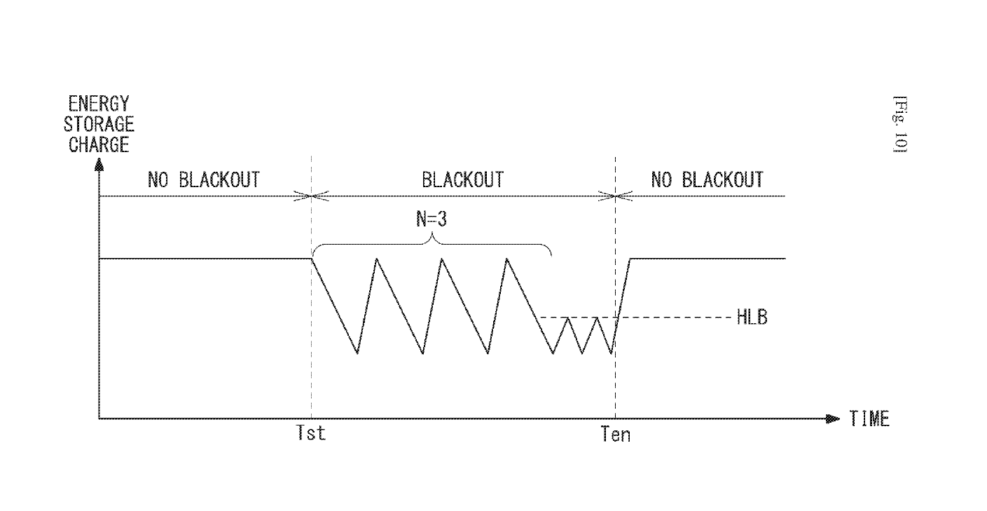

FIG. 10 is a diagram schematically illustrating charging and discharging operation according to the third embodiment. In FIG. 10, N=3. In the blackout span, the N cycles of full charging and discharging are performed at first. After that, the higher limit bound HLB is valid and the charge level of the energy storage 3 is limited to the higher limit bound HLB.

According to the present embodiment, if the blackout time span is relatively long, the number of the cycles of full charging and discharging is limited to the predefined value N. Therefore, it is possible to preferably suppress the aging of the energy storage 3.

### Other Embodiment

Note that the present invention is not limited to the above exemplary embodiments and can be modified as appropriate without departing from the scope of the invention. For example, the energy management systems where one energy storage, one local controller and one load are provided in the energy management system, however, it is merely examples. Thus, it should be appreciated that the prediction unit can include two or more local controllers, two or more energy storages and two or more loads, and the guide server can provides each of the two or more local controllers and monitors of conditions of the two or more energy storages and two or more loads.

In the above exemplary embodiments, the present invention is described as a hardware configuration, but the operation of the guide server can be implemented by causing a CPU (Central Processing Unit) to execute a computer program. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line, such as electric wires and optical fibers, or a wireless communication line.

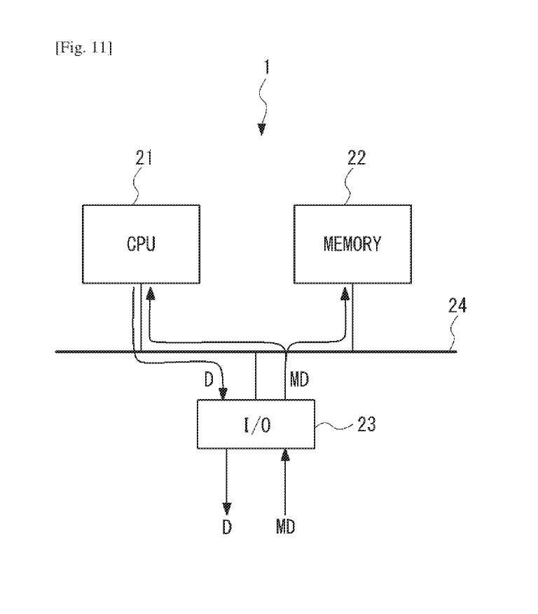

For, example, the guide server 1 can be configured using a CPU. FIG. 11 is a diagram schematically illustrating an exemplary configuration of the guide server. In this case, the guide server 1 includes a CPU 21, a memory 22, an input/output interface (I/O) 23 and a bus 24. The CPU 21, the memory 22 and the input/output interface (I/O) 23 can communicate each other via the bus 24. The CPU 21 achieves functions of the generation prediction unit 11, the load prediction unit 12, the time uncertain phenomena prediction unit 13, the controller 17 and the optimizer 18 by executing the program. The memory 22 corresponds to the generation prediction buffer 14, the load prediction buffer 15 and the time uncertain phenomena prediction buffer 16. The input/output interface (I/O) 23 receives the measurement data MD and output the directive D.

While the present invention has been described above with reference to exemplary embodiments, the present invention is not limited to the above exemplary embodiments. The configuration and details of the present invention can be modified in various ways which can be understood by those skilled in the art within the scope of the invention.

### REFERENCE SIGNS LIST

100 ENERGY MANAGEMENT SYSTEM
1 GUIDE SERVER
2 LOCAL CONTROLLER
3 ENERGY STORAGE
4 LOAD
10 GRID LINE
11 GENERATION PREDICTION UNIT
12 LOAD PREDICTION UNIT
12A, 12B PREDICTION UNITS
12C DEVICE SIMULATOR
13 TIME UNCERTAIN PHENOMENA PREDICTION UNIT
13A NONLINEAR PRE-PROCESSING UNIT
13B FEATURE EXTRACTION UNIT 13B
13C MEMORY UNIT
13D PATTERN RECOGNITION UNIT
14 GENERATION PREDICTION BUFFER
15 LOAD PREDICTION BUFFER
16 TIME UNCERTAIN PHENOMENA PREDICTION BUFFER
17 CONTROLLER
18 OPTIMIZER
18A PROBLEM FORMULATION MODULE
18B OPTIMAL SOLVER
21 CPU
22 MEMORY
23 INPUT/OUTPUT INTERFACE (I/O)
24 BUS

1. An energy management system comprising:
energy storage configured to be charged and discharged, and connected to a grid line, the grid line being supplied with power from at least one outside power generator or from the energy storage itself
a load configured to operate with consuming power supplied via the grid line;
a guide server configured to predict conditions of the energy storage, the load and the grid line and to generate a directive corresponding to the prediction, and outputs the generated directive and
a local controller configured to control charging and discharging of the energy storage based on or guided by the directive generated in the guide server.

2. The energy management system according to claim 1, wherein the guide server comprises:
a controller configured to determine whether to generate the directive based on the conditions of the energy storage, the load, and the grid line; and
an optimizer configured to generate the directive according to trigger information from the controller and outputs the generated directive to the local controller.

3. The energy management system according to claim 1, wherein
the local controller can keep a plurality directives temporally overlapping with each other, makes only the directive whose time span includes the current time instant and is the shortest be valid and controls the energy storage based on the valid directive.

4. The energy management system according to claim 2, wherein
the guide server comprises further comprises:
a generation prediction unit configured to predict power generation of the outside power generator;
a load prediction unit configured to predict power consumption of the load;
a time uncertain phenomena prediction unit configured to predict occurrences of time uncertain phenomena;
a generation prediction buffer configured to store a prediction generated by the generation prediction unit;
a load prediction buffer configured to store a prediction generated by the load prediction unit; and
a time uncertain phenomena prediction buffer configured to store a prediction generated by the time uncertain phenomena prediction unit, and
when the controller determines to generate the directive, the generation prediction unit, the load prediction unit and the time uncertain phenomena prediction unit generates predictions and outputs the generated predictions to the generation prediction buffer, the load prediction buffer and the time uncertain phenomena prediction buffer, respectively, and the optimizer reads in the predictions from the generation prediction buffer, the load prediction buffer and the time uncertain phenomena prediction buffer to generate the directive.

5. The energy management system according to claim 4, wherein the controller causes the generation prediction unit, the load prediction unit and the time uncertain phenomena prediction unit to generate the predictions and causes the optimizer to generate the directive, when the latest predicted values read out from the generation prediction buffer, the load prediction buffer, and the time uncertain phenomena prediction buffer are not compatible with the measurement data or the deviation between the measurement data and the latest predicted value is larger than a predetermined value.

6. The energy management system according to claim 4, wherein, when the time uncertain phenomenon occurs, the controller causes the generation prediction unit, the load prediction unit and the time uncertain phenomena prediction unit to generate the predictions and causes the optimizer to generate the directive, when the time uncertain phenomenon occurs after a predefined time from the occurrence of the time uncertain phenomenon.

7. The energy management system according to claim 4, wherein the controller periodically causes the generation prediction unit, the load prediction unit and the time uncertain phenomena prediction unit to generate the predictions and periodically causes the optimizer to generate the directive in order to perform a periodic update of the predictions and directives.

8. The energy management system according to claim 4,
the time uncertain phenomena prediction unit includes:
a memory unit configured to store past measurement data from the outside,
a nonlinear pre-processing unit configured to process latest measurement data received from the outside and the past measurement data received from the memory unit, and output the processed data,
a feature extraction unit configured to extract a feature from the processed data output from the nonlinear pre-processing unit and output the extracted feature,
a pattern recognition unit configured to determine to which a region of feature space the extracted feature belongs and derive probabilities or a probability function of duration(s) of the time uncertain phenomena from a degree of belonging to each region.

9. A guide sever comprising:
a controller configured to predict conditions of energy storage, a load, and a grid line and to determine whether to generate a directive corresponding to the prediction; and
an optimizer configured to generate the directive according to trigger information received from the controller and outputs the generated directive to a local controller, wherein
the energy storage is configured to be charged and discharged, and connected to a grid line,
the grid line is supplied with power from at least one outside power generator or from the energy storage itself;
the load is configured to operate with consuming power supplied via the grid line; and
the local controller is configured to control charging and discharging of the energy storage based on or guided by the directive generated in the optimizer.

10. An energy management method comprising:
predicting conditions of energy storage, a load and a grid line, the energy storage being configured to be charged and discharged, and connected to the grid line, the grid line being supplied with power from at least one outside power generator or from the energy storage itself, the load being configured to operate with consuming power supplied via the grid line;
generating a directive corresponding to the prediction;
outputting the generated directive; and
controlling the charging and discharging of the energy storage based on the generated directive
